(19) United States
(12) Patent Application Publication
(10) Pub. No.: US 2020/0035241 A1
(43) Pub. Date: Jan. 30, 2020

(54) METHOD, DEVICE AND COMPUTER STORAGE MEDIUM FOR SPEECH INTERACTION

(71) Applicant: BAIDU ONLINE NETWORK TECHNOLOGY (BEIJING) CO., LTD., Beijing (CN)

(72) Inventor: Xiantang CHANG, Beijing (CN)

(73) Assignee: BAIDU ONLINE NETWORK TECHNOLOGY (BEIJING) CO., LTD., Beijing (CN)

(21) Appl. No.: 16/425,513

(22) Filed: May 29, 2019

(30) Foreign Application Priority Data
Jul. 24, 2018 (CN) 201810816608X

(51) Int. Cl. G10L 15/26; G10L 17/02

(52) U.S. Cl. CPC G10L 15/26; G10L 17/02

(57) ABSTRACT

A method, a device and a computer storage medium for speech interaction are disclosed. The method includes: receiving speech data transmitted by a first terminal device; obtaining a speech recognition result and a voiceprint recognition result of the speech data; obtaining a response text for the speech recognition result, and performing speech conversion for the response text with the voiceprint recognition result; and transmitting audio data obtained from the conversion to the first terminal device. Speech self-adaptation of human-machine interaction may be achieved, and the real feeling and interest of human-machine speech interaction may be enhanced and improved, respectively.

### CROSS REFERENCE TO RELATED APPLICATIONS

This application claims priority to Chinese Patent Application No. 201810816608.X, filed on Jul. 24, 2018, which is incorporated herein by reference in its entirety.

### TECHNICAL FIELD

The present disclosure relates to the technical field of the Internet, and particularly to a method, a device and a computer storage medium for speech interaction.

### BACKGROUND

When a smart terminal device in the prior art performs speech interaction, it generally uses a fixed response sound to interact with a user, resulting in a tedious process of speech interaction between the user and the terminal device.

### SUMMARY

In view of the above, the present disclosure provides a method, an apparatus, a device and a computer storage medium for speech interaction, to improve real feeling and interest of human-machine speech interaction.

A technical solution employed by the present disclosure to solve the technical problem proposes a speech interaction method which includes: receiving speech data transmitted by a first terminal device; obtaining a speech recognition result and a voiceprint recognition result of the speech data; obtaining a response text for the speech recognition result, and performing speech conversion for the response text with the voiceprint recognition result; transmitting audio data obtained from the conversion to the first terminal device.

According to an embodiment of the present disclosure, the voiceprint recognition result includes at least one kind of identity information of user's gender, age, region and occupation.

According to an embodiment of the present disclosure, the obtaining a response text for the speech recognition result includes: performing searching and matching with the speech recognition result to obtain at least one of a text search result and a prompt text corresponding to the speech recognition result.

According to an embodiment of the present disclosure, the method further includes: under the condition that an audio search result is obtained by performing searching and matching with the speech recognition result, transmitting the audio search result to the first terminal device.

According to an embodiment of the present disclosure, the obtaining a response text for the speech recognition result includes: performing searching and matching with the speech recognition result and the voiceprint recognition result to obtain at least one of a text search result and/or a prompt text corresponding to the speech recognition result and the voiceprint recognition result.

According to an embodiment of the present disclosure, the performing speech conversion for the response text with the voiceprint recognition result includes: determining a voice synthesis parameter corresponding to the voiceprint recognition result according to a correspondence relationship between preset identity information and the voice synthesis parameter; and performing the speech conversion for the response text with the determined voice synthesis parameter.

According to an embodiment of the present disclosure, the method further includes: receiving and storing the correspondence relationship set by a second terminal device.

According to an embodiment of the present disclosure, before performing speech conversion for the response text with the voiceprint recognition result, the method further includes: judging whether the first terminal device is set as a self-adaptive speech response, under the condition that the first terminal device is set as a self-adaptive speech response, continuing to perform speech conversion for the response text with the voiceprint recognition result; and under the condition that the first terminal device is not set as a self-adaptive speech response, performing speech conversion for the response text with a preset or default voice synthesis parameter.

A technical solution employed by the present disclosure to solve the technical problem proposes an apparatus for speech interaction which includes: a receiving unit configured to receive speech data transmitted by a first terminal device; a processing unit configured to obtain a speech recognition result and a voiceprint recognition result of the speech data; a converting unit configured to obtain a response text for the speech recognition result, and perform speech conversion for the response text with the voiceprint recognition result; a transmitting unit configured to transmit audio data obtained from the conversion to the first terminal device.

According to an embodiment of the present disclosure, the voiceprint recognition result includes at least one kind of identity information of user's gender, age, region and occupation.

According to an embodiment of the present disclosure, upon obtaining a response text for the speech recognition result, the converting unit specifically performs: performing searching and matching with the speech recognition result to obtain at least one of a text search result and a prompt text corresponding to the speech recognition result.

According to an embodiment of the present disclosure, the converting unit is further configured to perform: under the condition that an audio search result is obtained by performing searching and matching with the speech recognition result, transmitting the audio search result to the first terminal device.

According to an embodiment of the present disclosure, upon obtaining a response text for the speech recognition result, the converting unit specifically performs: performing searching and matching with the speech recognition result and the voiceprint recognition result to obtain at least one of a text search result and a prompt text corresponding to the speech recognition result and voiceprint recognition result.

According to an embodiment of the present disclosure, upon performing speech conversion for the response text with the voiceprint recognition result, the converting unit specifically performs: determining a voice synthesis parameter corresponding to the voiceprint recognition result according to a correspondence relationship between preset identity information and the voice synthesis parameter; and performing the speech conversion for the response text with the determined voice synthesis parameter.

According to an embodiment of the present disclosure, the converting unit is further configured to perform: receiving and storing the correspondence relationship set by a second terminal device.

According to an embodiment of the present disclosure, before performing speech conversion for the response text with the voiceprint recognition result, the converting unit specifically performs: judging whether the first terminal device is set as a self-adaptive speech response, under the condition that the first terminal device is set as a self-adaptive speech response, continuing to perform the speech conversion for the response text with the voiceprint recognition result; and under the condition that the first terminal device is not set as a self-adaptive speech response, performing speech conversion for the response text with a preset or default voice synthesis parameter.

As may be seen from the above technical solutions, the voice synthesis parameter is dynamically obtained through the speech data input by the user to perform speech conversion for the response text corresponding to the speech recognition result so that the audio data obtained from the conversion conforms to the user's identity information, thereby achieving speech self-adaptation of human-machine interaction, enhancing the real feeling of human-machine speech interaction, and improving interest of the human-machine speech interaction.

### BRIEF DESCRIPTION OF THE DRAWINGS

FIG. 1 is a flowchart illustrating a method for speech interaction according to an embodiment of the present disclosure.

FIG. 2 is a structural diagram of an apparatus for speech interaction according to an embodiment of the present disclosure.

FIG. 3 is a block diagram of a computer system/server according to an embodiment of the present disclosure.

### DETAILED DESCRIPTION

The present disclosure will be described in detail in conjunction with figures and specific embodiments to make objectives, technical solutions and advantages of the present disclosure more apparent.

Terms used in embodiments of the present disclosure are only intended to describe specific embodiments, not to limit the present disclosure. Singular forms “a”, “said” and “the” used in embodiments and claims of the present disclosure are also intended to include plural forms, unless otherwise indicated in the context.

It should be appreciated that the term “and/or” used in the text is only an association relationship depicting associated objects and represents that three relations might exist, for example, A and/or B may represent three cases, namely, A exists individually, both A and B coexist, and B exists individually. In addition, the symbol “/” in the text generally indicates associated objects before and after the symbol are in an “or” relationship.

Depending on the context, the word “if” as used herein may be construed as “at the time when . . . ” or “when . . . ” or “responsive to determining” or “responsive to detecting”. Similarly, depending on the context, phrases “if . . . is determined” or “if . . . (stated condition or event) is detected” may be construed as “when . . . is determined” or “responsive to determining” or “when . . . (stated condition or event) is detected” or “responsive to detecting (stated condition or event)”.

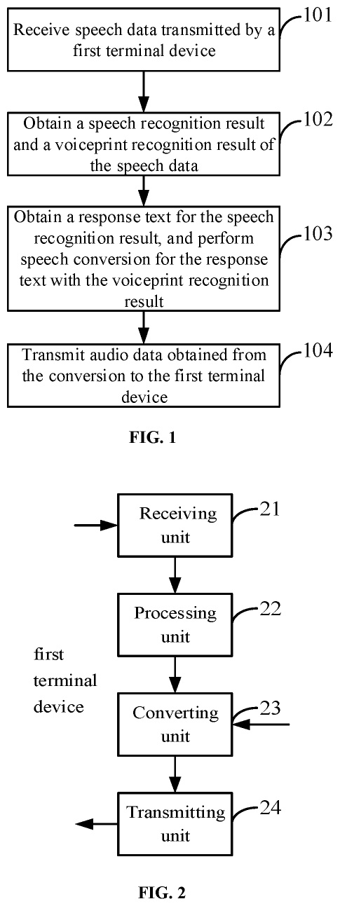

FIG. 1 is a flowchart illustrating a method for speech interaction according to an embodiment of the present disclosure. As shown in FIG. 1, the method is executed at a server side and includes:

At 101, speech data transmitted by a first terminal device is received.

In this step, the server side receives the speech data transmitted by the first terminal device and input by the user. In the present disclosure, the first terminal device is a smart terminal device, such as a smart phone, a tablet computer, a smart wearable device, a smart speaker, a smart household appliance, etc., and the smart device has the capability of obtaining user speech data and playing audio data.

The first terminal device collects the speech data input by the user through a microphone, and sends the collected speech data to the server side when the first terminal device is in an awake state.

At 102, a speech recognition result and a voiceprint recognition result of the speech data are obtained.

In this step, speech recognition and voiceprint recognition are performed for the speech data received in step 101, thereby respectively obtaining the speech recognition result and the voiceprint recognition result corresponding to the speech data.

It may be understood that when the speech recognition result and the voiceprint recognition result of the speech data are obtained, the speech recognition and voiceprint recognition may be performed for the speech data on the server side; the speech recognition and voiceprint recognition may also be performed for the speech data at the first terminal device, and the first terminal device sends the speech data, and the speech recognition result and the voiceprint recognition result corresponding to the speech data to the server side; the server side may send the received speech data to a speech recognition server and a voiceprint recognition server, respectively, and then obtain the speech recognition result and the voiceprint recognition result of the speech data from the two servers.

The voiceprint recognition result of the speech data includes at least one kind of identity information of the user's gender, age, region and occupation. The user's gender means that the user is a male or a female, and the user's age means that the user is a child, a youth, the middle-aged or the elderly.

Specifically, the speech recognition result corresponding to the speech data obtained by performing speech recognition for the speech data is generally text data; the voiceprint recognition is performed for the speech data to obtain the voiceprint recognition result corresponding to the speech data. It may be appreciated that the speech recognition and the voiceprint recognition involved by the present disclosure belong to the prior art, and are not described in detail any more herein, and the order of performing the speech recognition and the voiceprint recognition is not limited in the present disclosure.

In addition, before performing the speech recognition and voiceprint recognition for the speech data, the method may further include the following contents: performing denoising processing for the speech data, and performing the speech recognition and voiceprint recognition with the speech data after the denoising processing, thereby improving the accuracy of the speech recognition and voiceprint recognition.

At 103, a response text for the speech recognition result is obtained, and the voiceprint recognition result is used to perform speech conversion for the response text.

In this step, searching and matching is performed according to the speech recognition result corresponding to the speech data obtained in step 102, the response text corresponding to the speech recognition result is obtained, and then the voiceprint recognition result is used to perform speech conversion for the response text, to obtain the audio data corresponding to the response text.

The speech recognition result of the speech data is text data. Generally, when search is performed only according to the text data, all search results corresponding to the text data are obtained, and search results adapted for different genders, different ages, different regions and different occupations are not obtained. Therefore, when the searching and matching is performed with the speech recognition result in this step, the following manner may be adopted: performing searching and matching with the speech recognition result and the voiceprint recognition result to obtain the search result corresponding to the speech recognition result and the voiceprint recognition result. In the present disclosure, it is possible to, by performing the search in conjunction with the obtained voiceprint recognition result, enable the obtained search result to conform to the user's identity information in the voiceprint recognition result, thereby achieving the purpose of obtaining a more accurate search result which more conforms to the user's expectation.

When searching and matching is performed with the speech recognition result and the voiceprint recognition result, the following manner may be employed: firstly, performing searching and matching with the speech recognition result to obtain the search result corresponding to the speech recognition result; then calculating a matching degree between the voiceprint recognition result and the obtained search results, and taking a search result whose matching degree exceeds a preset threshold as the search result corresponding to the speech recognition result and the voiceprint recognition result. The present disclosure does not limit the manner of obtaining the search result with the speech recognition result and the voiceprint recognition result.

For example, if the user's identity information in the voiceprint recognition result is a child, when a search result is obtained in this step, a search result more suitable for the child is obtained. If the user's identity information in the voiceprint recognition result is male, when a search result is obtained in this step, a search result more suitable for the male is obtained.

When the searching and matching is performed according to the speech recognition result, a search engine may be directly used for searching to obtain the search result corresponding to the speech recognition result.

a. The following manner may also be employed: determining a vertical server corresponding to the speech recognition result; performing a search in the determined vertical server according to the speech recognition result, thereby obtaining a corresponding search result. For example, if the speech recognition result is “to recommend several inspirational songs”, a corresponding vertical server is determined to be a music vertical server according to the speech recognition result, and if the user's identity information in the voiceprint recognition result is male, a search result “inspirational songs for males” is obtained by searching from the music vertical server.

In this step, the speech recognition result is used for searching and matching to obtain the response text corresponding to the speech recognition result. The response text corresponding to the speech recognition result includes a text search result and/or a prompt text corresponding to the speech recognition result, and the prompt text is used to prompt the user that play will be performed next before the first terminal device plays.

For example, if the speech recognition result is “playing several inspirational songs”, the corresponding prompt text may be “will play the songs for you”; if the speech recognition result is “to query for names of several inspirational songs”, the corresponding prompt text may be “found the following content for you”.

In addition, in this step, after the response text corresponding to the speech recognition result is obtained, the voiceprint recognition result is further used to perform speech conversion for the obtained response text.

It may be appreciated that, before performing the speech conversion for the obtained response text with the voiceprint recognition result, the method further includes: judging whether the first terminal device is set as a self-adaptive speech response, under the condition that the first terminal device is set as a self-adaptive speech response, performing the speech conversion for the obtained response text with the voiceprint recognition result; and under the condition that the first terminal device is not set as a self-adaptive speech response, performing the speech conversion for the response text with a preset or default voice synthesis parameter.

Specifically, when the speech conversion is performed for the response text with the voiceprint recognition result, the following manner may be employed: determining a voice synthesis parameter corresponding to the voiceprint recognition result according to a correspondence relationship between the preset identity information and the voice synthesis parameter; performing the speech conversion for the response text with the determined voice synthesis parameter, thereby obtaining audio data corresponding to the response text.

For example, if the user's identity information is a child, it is determined that the voice synthesis parameter corresponding to the child is a “child” voice synthesis parameter, and then the speech conversion is performed for the response text with the determined “child” voice synthesis parameter, so that the voice in the audio data obtained from the conversion is a child's voice.

It may be appreciated that the correspondence relationship between the identity information and the voice synthesis parameter in the server side is set by a second terminal device, and the second terminal device may be the same as or different from the first terminal device. The second terminal device sends the set correspondence relationship to the server side, and the server side saves the correspondence relationship, so that the server side may determine the voice synthesis parameter corresponding to the user's identity information according to the correspondence relationship. The voice synthesis parameter may include parameters such as pitch, length and intensity of the voice.

In general, the voice synthesis parameter used upon performing the speech conversion for the search result is fixed, that is, the voice in the audio data after speech conversion obtained by different users is fixed. However, in the present disclosure, the voice synthesis parameter corresponding to the user's identity information is dynamically obtained according to the voiceprint recognition result, so that the voice in the audio data after speech conversion obtained by different users corresponds to the user's identity information, thereby improving the user's interactive experience.

At 104, the audio data obtained from the conversion is transmitted to the first terminal device.

In this step, the audio data obtained from the conversion in step 103 is transmitted to the first terminal device for the first terminal device to play feedback content corresponding to the user's speech data.

It may be appreciated that under the condition that the obtained search result is an audio search result when the speech recognition result is used for matching and searching, speech conversion needn't be performed for the speech search result, and the audio search result is directly sent to the first terminal device.

In addition, if the prompt text corresponding to the speech recognition result is obtained according to the speech recognition result, the audio data corresponding to the prompt text may be added before the audio search result or the audio data corresponding to the text search result, so that the first terminal device plays the audio data corresponding to the prompt text before playing the audio search result or the audio data corresponding to the text search result, thereby ensuring that the first terminal device is more smooth when playing the feedback content corresponding to the speech data input by the user.

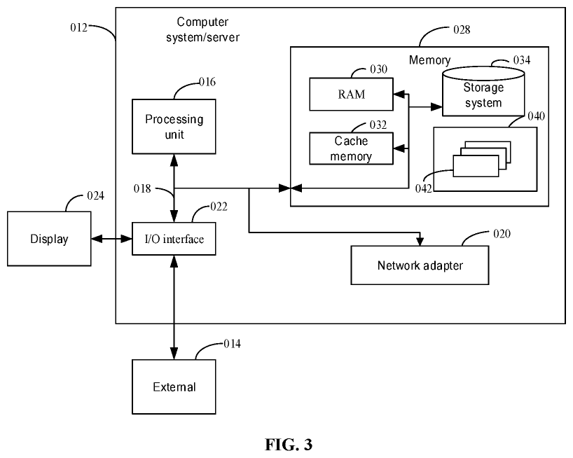

FIG. 2 is a structural diagram of an apparatus for speech interaction according to an embodiment of the present disclosure. As shown in FIG. 2, the apparatus is located at a server side and includes: a receiving unit 21 configured to receive speech data transmitted by a first terminal device.

The receiving unit 21 receives the speech data transmitted by the first terminal device and input by the user. In an embodiment of the present disclosure, the first terminal device is a smart terminal device, such as a smart phone, a tablet computer, a smart wearable device, a smart speaker, a smart household appliance, etc., and the smart device has the capability of obtaining user's speech data and playing audio data.

The first terminal device collects the speech data input by the user through a microphone, and sends the collected speech data to the receiving unit 21 when the first terminal device is in an awake state.

A processing unit 22 configured to obtain a speech recognition result and a voiceprint recognition result of the speech data.

The processing unit 22 performs speech recognition and voiceprint recognition for the speech data received the receiving unit 21, thereby respectively obtaining the speech recognition result and the voiceprint recognition result corresponding to the speech data.

It may be understood that when the speech recognition result and the voiceprint recognition result of the speech data are obtained, the processing unit 22 may perform the speech recognition and voiceprint recognition for the speech data; the processing unit 22 may also transmit the speech data, speech recognition result and voiceprint recognition result together to the service side after the first terminal device performs speech recognition and voiceprint recognition for the speech data; the processing unit 22 may also send the received speech data to a speech recognition server and a voiceprint recognition server, respectively, and then obtain the speech recognition result and the voiceprint recognition result of the speech data from the two servers.

The voiceprint recognition result of the speech data includes at least one kind of identity information of the user's gender, age, region and occupation. The user's gender means that the user may be a male or a female, and the user's age means that the user is a child, a youth, the middle-aged or the elderly.

Specifically, the speech recognition result corresponding to the speech data obtained by the processing unit 22 by performing speech recognition for the speech data is generally text data; the processing unit 22 performs voiceprint recognition for the speech data to obtain the voiceprint recognition result corresponding to the speech data. It may be appreciated that the speech recognition and the voiceprint recognition involved by the present disclosure belong to the prior art, and are not described in detail any more herein, and the order of performing the speech recognition and the voiceprint recognition is not limited in the present disclosure.

In addition, the processing unit 22 may further perform the following contents before performing the speech recognition and voiceprint recognition for the speech data: performing denoising processing for the speech data, and performing the speech recognition and voiceprint recognition with the speech data after the denoising processing, thereby improving the accuracy of the speech recognition and voiceprint recognition.

A converting unit 23 is configured to obtain a response text for the speech recognition result, and perform speech conversion for the response text with the voiceprint recognition result.

The converting unit 23 performs searching and matching according to the speech recognition result corresponding to the speech data obtained by the processing unit 22, obtains the response text corresponding to the speech recognition result, and then uses the voiceprint recognition result to perform speech conversion for the response text, to obtain the audio data corresponding to the response text.

The speech recognition result of the speech data is text data. Generally, when search is performed only according to the text data, all search results corresponding to the text data are obtained, and search results adapted for different genders, different ages, different regions and different occupations are not obtained.

Therefore, upon performing the searching and matching with the speech recognition result, the converting unit 23 may also employ the following manner: performing searching and matching with the speech recognition result and the voiceprint recognition result to obtain the search result corresponding to the speech recognition result and the voiceprint recognition result. The converting unit 23, by performing the search in conjunction with the obtained voiceprint recognition result, enables the obtained search result to conform to the user's identity information in the voiceprint recognition result, thereby achieving the purpose of obtaining a more accurate search result which more conforms to the user's expectation.

Upon performing searching and matching with the speech recognition result and the voiceprint recognition result, the converting unit 23 may employ the following manner: firstly, performing searching and matching with the speech recognition result to obtain the search result corresponding to the speech recognition result; then calculating a matching degree between the voiceprint recognition result and the obtained search results, and taking a search result whose matching degree exceeds a preset threshold as the search result corresponding to the speech recognition result and the voiceprint recognition result. The present disclosure does not limit the manner of the converting unit 23 obtaining the search result with the speech recognition result and the voiceprint recognition result.

Upon performing the searching and matching according to the speech recognition result, the converting unit 23 may directly use a search engine to search to obtain the search result corresponding to the speech recognition result.

The converting unit 23 may employ the following manner: determining a vertical server corresponding to the speech recognition result; performing a search in the determined vertical server according to the speech recognition result, thereby obtaining a corresponding search result.

The converting unit 23 uses the speech recognition result to perform searching and matching to obtain the response text corresponding to the speech recognition result. The response text corresponding to the speech recognition result includes a text search result and/or a prompt text corresponding to the speech recognition result, and the prompt text is used to prompt the user that play will be performed next before the first terminal device plays.

In addition, after obtaining the response text corresponding to the speech recognition result, the converting unit 23 further uses the voiceprint recognition result to perform speech conversion for the obtained response text.

It may be appreciated that, before performing the speech conversion for the obtained response text with the voiceprint recognition result, the converting unit 23 further performs the following content: judging whether the first terminal device is set as an adaptive speech response, and if the first terminal device is set as an adaptive speech response, performing the speech conversion for the obtained response text with the voiceprint recognition result; if the first terminal device is not set as an adaptive speech response, performing the speech conversion for the response text with a preset or default voice synthesis parameter.

Specifically, upon performing the speech conversion for the response text with the voiceprint recognition result, the converting unit 23 may employ the following manner: determining a voice synthesis parameter corresponding to the voiceprint recognition result according to a correspondence relationship between the preset identity information and the voice synthesis parameter; performing the speech conversion for the response text with the determined voice synthesis parameter, thereby obtaining audio data corresponding to the response text.

It may be appreciated that the correspondence relationship between the identity information and the voice synthesis parameter in the converting unit 23 is set by a second terminal device, and the second terminal device may be the same as or different from the first terminal device. The second terminal device sends the set correspondence relationship to the converting unit 23, and the converting unit 23 saves the correspondence relationship, so that the converting unit 23 can determine the voice synthesis parameter corresponding to the user's identity information according to the correspondence relationship. The voice synthesis parameter may include parameters such as pitch, length and intensity of the voice.

A transmitting unit 24 is configured to transmit the audio data obtained from the conversion to the first terminal device.

The transmitting unit 24 transmits the audio data obtained from the conversion of the converting unit 23 to the first terminal device for the first terminal device to play feedback content corresponding to the user's speech data.

It may be appreciated that if the obtained search result is an audio search result when the converting unit 23 uses the speech recognition result to perform matching and searching, speech conversion needn't be performed for the speech search result, and the transmitting unit 24 directly transmits the audio search result to the first terminal device.

In addition, if the converting unit 23 obtains the prompt text corresponding to the speech recognition result according to the speech recognition result, the transmitting unit 24 adds the audio data corresponding to the prompt text before the audio search result or the audio data corresponding to the text search result, so that the first terminal device plays the audio data corresponding to the prompt text before playing the audio search result or the audio data corresponding to the text search result, thereby ensuring that the first terminal device is more smooth when playing the feedback content corresponding to the speech data input by the user.

FIG. 3 illustrates a block diagram of an example computer system/server 012 adapted to implement an implementation mode of the present disclosure. The computer system/server 012 shown in FIG. 3 is only an example and should not bring about any limitation to the function and scope of use of the embodiments of the present disclosure.

As shown in FIG. 3, the computer system/server 012 is shown in the form of a general-purpose computing device. The components of computer system/server 012 may include, but are not limited to, one or more processors or processing units 016, a memory 028, and a bus 018 that couples various system components including system memory 028 and the processor 016.

Bus 018 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 012 typically includes a variety of computer system readable media. Such media may be any available media that is accessible by computer system/server 012, and it includes both volatile and non-volatile media, removable and non-removable media.

Memory 028 may include computer system readable media in the form of volatile memory, such as random access memory (RAM) 030 and/or cache memory 032. Computer system/server 012 may further include other removable/non-removable, volatile/non-volatile computer system storage media. By way of example only, storage system 034 may be provided for reading from and writing to a non-removable, non-volatile magnetic media (not shown in FIG. 3 and typically called a “hard drive”). Although not shown in FIG. 3, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each drive may be connected to bus 018 by one or more data media interfaces. The memory 028 may include at least one program product having a set (e.g., at least one) of program modules that are configured to carry out the functions of embodiments of the present disclosure.

Program/utility 040, having a set (at least one) of program modules 042, may be stored in the system memory 028 by way of example, and not limitation, as well as an operating system, one or more disclosure programs, other program modules, and program data. Each of these examples or a certain combination thereof might include an implementation of a networking environment. Program modules 042 generally carry out the functions and/or methodologies of embodiments of the present disclosure.

Computer system/server 012 may also communicate with one or more external devices 014 such as a keyboard, a pointing device, a display 024, etc.; with one or more devices that enable a user to interact with computer system/server 012; and/or with any devices (e.g., network card, modem, etc.) that enable computer system/server 012 to communicate with one or more other computing devices. Such communication may occur via Input/Output (I/O) interfaces 022. Still yet, computer system/server 012 may communicate with one or more networks such as a local area network (LAN), a general wide area network (WAN), and/or a public network (e.g., the Internet) via network adapter 020. As depicted in FIG. 3, network adapter 020 communicates with the other communication modules of computer system/server 012 via bus 018. It should be understood that although not shown, other hardware and/or software modules could be used in conjunction with computer system/server 012. Examples, include, but are not limited to: microcode, device drivers, redundant processing units, external disk drive arrays, RAID systems, tape drives, and data archival storage systems, etc.

The processing unit 016 executes various function applications and data processing by running programs stored in the memory 028, for example, implement the flow of the method according to embodiments of the present disclosure.

The aforesaid computer program may be arranged in the computer storage medium, namely, the computer storage medium is encoded with the computer program. The computer program, when executed by one or more computers, enables one or more computers to execute the flow of the method and/or operations of the apparatus as shown in the above embodiments of the present disclosure. For example, the flow of the method is performed by the one or more processors.

As time goes by and technologies develop, the meaning of medium is increasingly broad. A propagation channel of the computer program is no longer limited to tangible medium, and it may also be directly downloaded from the network. The computer-readable medium of the present embodiment may employ any combinations of one or more computer-readable media. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium may be any tangible medium that include or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

According to the technical solutions according to the present disclosure, the voice synthesis parameter is dynamically obtained through the speech data input by the user to perform speech conversion for the response text corresponding to the speech recognition result so that the audio data obtained from the conversion conforms to the user's identity information, thereby achieving speech self-adaptation of human-machine interaction, enhancing the real feeling of human-machine speech interaction, and improving interest of the human-machine speech interaction.

In the embodiments provided by the present disclosure, it should be understood that the revealed system, apparatus and method may be implemented in other ways. For example, the above-described embodiments for the apparatus are only exemplary, e.g., the division of the units is merely logical one, and, in reality, they may be divided in other ways upon implementation.

The units described as separate parts may be or may not be physically separated, the parts shown as units may be or may not be physical units, i.e., they may be located in one place, or distributed in a plurality of network units. One may select some or all the units to achieve the purpose of the embodiment according to the actual needs.

Further, in the embodiments of the present disclosure, functional units may be integrated in one processing unit, or they may be separate physical presences; or two or more units may be integrated in one unit. The integrated unit described above may be implemented in the form of hardware, or they may be implemented with hardware plus software functional units.

The aforementioned integrated unit in the form of software function units may be stored in a computer readable storage medium. The aforementioned software function units are stored in a storage medium, including several instructions to instruct a computer device (a personal computer, server or network equipment, etc.) or processor to perform some steps of the method described in the various embodiments of the present disclosure. The aforementioned storage medium includes various media that may store program codes, such as U disk, removable hard disk, ROM, RAM, magnetic disk, or an optical disk.

What are stated above are only preferred embodiments of the present disclosure and not intended to limit the present disclosure. Any modifications, equivalent substitutions and improvements made within the spirit and principle of the present disclosure all should be included in the extent of protection of the present disclosure.

What is claimed is:

1. A method for speech interaction, comprising:
receiving speech data transmitted by a first terminal device;
obtaining a speech recognition result and a voiceprint recognition result of the speech data;
obtaining a response text for the speech recognition result, and performing speech conversion for the response text with the voiceprint recognition result; and
transmitting audio data obtained from the conversion to the first terminal device.

2. The method according to claim 1, wherein the voiceprint recognition result comprises at least one kind of identity information of user's gender, age, region and occupation.

3. The method according to claim 1, wherein the obtaining a response text for the speech recognition result comprises:
performing searching and matching with the speech recognition result to obtain at least one of a text search result and a prompt text corresponding to the speech recognition result.

4. The method according to claim 3, further comprising:
under the condition that an audio search result is obtained by performing searching and matching with the speech recognition result, transmitting the audio search result to the first terminal device.

5. The method according to claim 1, wherein the obtaining a response text for the speech recognition result comprises:
performing searching and matching with the speech recognition result and the voiceprint recognition result to obtain at least one of a text search result and a prompt text corresponding to the speech recognition result and the voiceprint recognition result.

6. The method according to claim 1, wherein the performing speech conversion for the response text with the voiceprint recognition result comprises:
determining a voice synthesis parameter corresponding to the voiceprint recognition result according to a correspondence relationship between preset identity information and the voice synthesis parameter; and
performing the speech conversion for the response text with the determined voice synthesis parameter.

7. The method according to claim 6, further comprising:
receiving and storing the correspondence relationship set by a second terminal device.

8. The method according to claim 1, wherein before performing speech conversion for the response text with the voiceprint recognition result, the method further comprises:
judging whether the first terminal device is set as a self-adaptive speech response, under the condition that the first terminal device is set as a self-adaptive speech response, continuing to perform speech conversion for the response text with the voiceprint recognition result; and
under the condition that the first terminal device is not set as a self-adaptive speech response, performing speech conversion for the response text with a preset or default voice synthesis parameter.

9. A device, comprising:
one or more processors;
a storage for storing one or more programs,
said one or more programs are executed by said one or more processors to enable said one or more processors to implement a method for speech interaction, wherein the method comprises:
receiving speech data transmitted by a first terminal device;
obtaining a speech recognition result and a voiceprint recognition result of the speech data;
obtaining a response text for the speech recognition result, and performing speech conversion for the response text with the voiceprint recognition result; and
transmitting audio data obtained from the conversion to the first terminal device.

10. A storage medium comprising computer-executable instructions, when the computer-executable instructions are executed by a computer processor, the computer-executable instructions being used to implement a method for speech interaction, wherein the method comprises:
receiving speech data transmitted by a first terminal device;
obtaining a speech recognition result and a voiceprint recognition result of the speech data;
obtaining a response text for the speech recognition result, and performing speech conversion for the response text with the voiceprint recognition result; and
transmitting audio data obtained from the conversion to the first terminal device.
